(19) United States
(12) Patent Application Publication
(10) Pub. No.: US 2002/0169695 A1
(43) Pub. Date: Nov. 14, 2002

(54) Method of planning production schedule in semiconductor foundry

(75) Inventors: Heng-An Ko, Hsinchu Hsien (TW); Kenny J. Chien, Hsinchu (TW); Chi-Hui Yeh, Hsinchu (TW); Tom Chen, Taipei (TW); Eric Chen, Taipei Hsien (TW)

Correspondence Address: J. C. PATENTS, INC., 4 VENTURE, SUITE 250, IRVINE, CA, 92618, US

(73) Assignee: United Microelectronics Corp., Hsinchu (TW)

(21) Appl. No.: 09/852,607

(22) Filed: May 10, 2001

(51) Int. Cl. G06F 17/60

(52) U.S. Cl. 705/28

(57) ABSTRACT

A method of planning a production schedule by using a planning system, useful for a semiconductor foundry, is provided. When the sales order whose product needs to be subject to the backend process is entered, the planning system subtracts an available amount of the product in the warehouse from the demand of the sales order, and obtaining a balanced amount of the product which is still required. Then the system searches for the supplied amount of the product that can be provided from the foundry and the CTP capacity available for the backend process. The supplied amount is compared with the CTP capacity, and the smaller one is taken as the balanced amount of the product. The available amount of the product in the warehouse is added to the balanced amount of the product, obtaining a total amount of the product as the supply for the sales order.

### BACKGROUND OF THE INVENTION

1. Field of the Invention

The present invention relates to a method of planning a production schedule. Specifically, the present invention relates to a method of planning a production schedule by using a planning system, which is useful for a semiconductor foundry.

2. Description of the Related Art

Product demand and production demands are dependent on the needs of the market. Supply Chain Management is well applied in the art to keep the inventory of each stage of the semiconductor process at as optimum a level as possible. However, demand varies over time as the market changes dynamically.

The cycle time of a product is typically calculated according to the forecast of future demands and/or sales orders. In practice, forecast cannot always accurately follow the variation of the market or product demands. If the demand exceeds what can be supplied, starvation occurs. On the other hand, piling up of work in process (WIP) results from decreased demands. Therefore, in view of profit, to keep the inventory of each stage of the semiconductor process at an optimum level is very important.

FIG. 1 is a graph showing the equipment utilization (capacity) of a semiconductor foundry from the demand point of view.

FIG. 2 is a graph showing the equipment utilization of a semiconductor foundry from the supply point of view.

As shown in FIG. 1, from the demand point of view, the throughput of a foundry includes the capacity for the sales orders received, the capacity for ATP (Available to Promise) demand and the idle capacity. As shown in FIG. 2, from the supply point of view, the throughput of the semiconductor foundry includes the capacity for the sales orders and CTP (Capable to Promise) capacity.

When a sales order comes, the production schedule planner has to calculate the standard cycle time and obtain available capacity in the foundry as accurately as possible in order to confirm if the incoming sales order can be accepted. If the incoming sales order needs its products to be subject to other backend processes, the production schedule planner has to take the available capacity for the backend process into consideration.

A conventional production schedule is made statically. First, the planner confirms the capacity for each stage for the process and calculates how many products can be offered based on the capacities and received sales orders. Then, the planner informs the client about the delivery date and amount. However, this method takes several working days to exactly calculate delivery date and amount. Thus, the planner cannot confirm the exact delivery date and amount with the client instantaneously.

### SUMMARY OF THE INVENTION

It is one object of the present invention to provide a method of planning a production schedule in a semiconductor foundry to reduce the time for confirming the delivery date and amount.

It is another object of the present invention to provide a method of planning a production schedule by using a planning system. The method can instantaneously, dynamically respond to the capacity at each stage of the semiconductor process in order to help the schedule planner to confirm the sales order in a short time.

In one aspect of the present invention, a method of planning a production schedule in a semiconductor foundry is provided. According to the method of the present invention, when a sales order whose product does not need to be subjected to the backend process is entered, the planning system goes to search for the supplied amount of the product which can be provided from the semiconductor foundry. The demand of the sales order is compared with the supplied amount of the product that can be provided from the foundry and the smaller one is taken as the supply for the sales order.

When a sales order whose product does need to be subjected to the backend process is entered, the planning system subtracts the available amount of the product in the warehouse from the demand of the sales order, obtaining as a balance the amount of the product which is still required. Then the system searches for the supplied amount of the product that can be provided from the foundry and the CTP capacity available for the backend process. The supplied amount is compared with the CTP capacity, and the smaller one is taken as the balanced amount of the product. The available amount of the product in the warehouse is added to the balanced amount of the product, obtaining a total amount of the product as the supply for the sales order.

With the production schedule module of the present invention, the planner can be informed in several seconds about the throughput of the semiconductor foundry, such that it can be immediately confirmed if the sales order can be satisfied in short time.

The method of planning a production schedule according to the present invention helps the production schedule planner use capacity information for various processes to more exactly confirm the sales order.

Through the method of the present invention, different production lines in the semiconductor foundry can instantaneously and dynamically respond by quantifying conditions such as amount or period.

### BRIEF DESCRIPTION OF THE DRAWINGS

It is to be understood that both the foregoing general description and the following detailed description are exemplary, and are intended to provide further explanation of the invention as claimed.

The accompanying drawings are included to provide a further understanding of the invention, and are incorporated in and constitute a part of this specification. The drawings illustrate embodiments of the invention and, together with the description, serve to explain the principle of the invention. In the drawings,

FIG. 1 is a graph showing the equipment utilization (capacity) of a semiconductor foundry from the demand point of view;

FIG. 2 is a graph showing the equipment utilization of a semiconductor foundry from the supply point of view;

FIG. 3 is a flow chart showing a process schedule of a semiconductor foundry according to one preferred embodiment of the present invention;

FIG. 4 is a flow chart of a production schedule for a product according to one preferred embodiment of the present invention; and

FIG. 5 is a flow chart of a production schedule for two products which are subject to the same processes according to another preferred embodiment of the present invention.

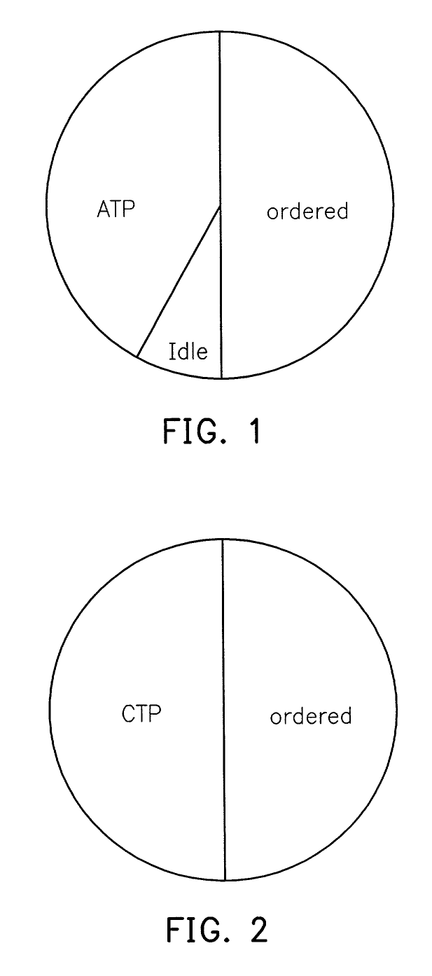

### DESCRIPTION OF THE PREFERRED EMBODIMENT

Reference will now be made in detail to the present preferred embodiments of the invention, examples of which are illustrated in the accompanying drawings. Whenever possible, the same reference numbers are used in the drawings and the description to refer to the same or like parts.

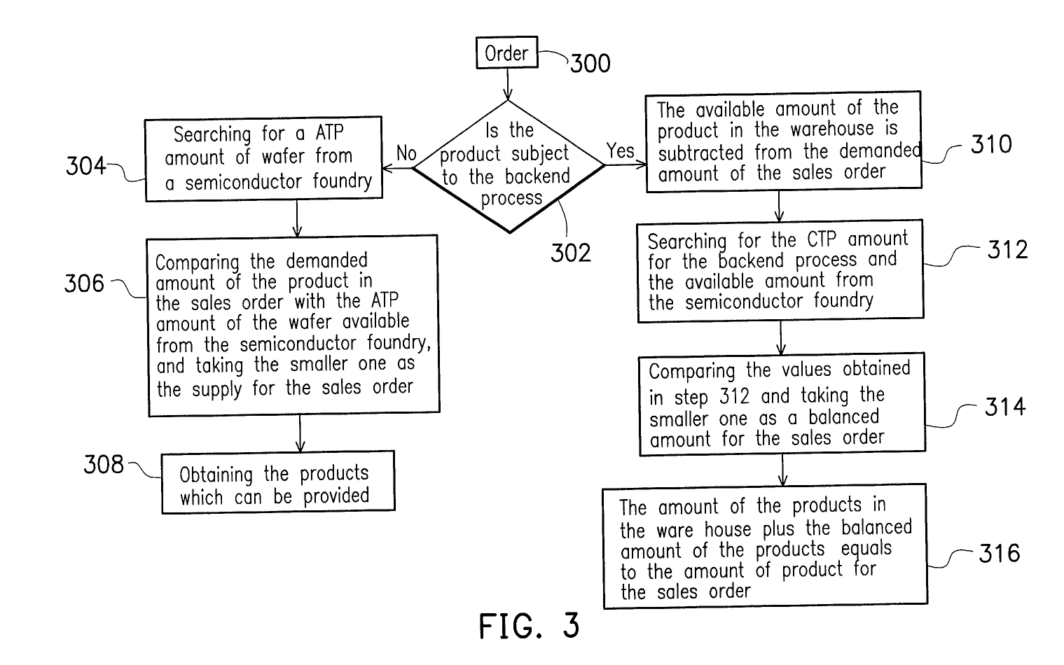

FIG. 3 is a flow chart showing a process schedule of a semiconductor foundry according to one preferred embodiment of the present invention.

Referring to FIG. 3, when a semiconductor foundry receives a sales order 300, it is required to confirm which products of the sales order 300 need to be subjected to the semiconductor backend process (step 302).

In one preferred embodiment of the present invention, if the products of the sales order 300 do not need to be subjected to the semiconductor backend process, then the system of the present invention searches for the ATP (Available to Promise) amount of the wafer from the semiconductor foundry (step 304). Subsequently, comparison between the demand of the sales order and the ATP amount of the wafer from the semiconductor foundry is carried out and the smaller of the two is taken (step 306). The smaller amount of the product is considered the amount of the product that can be provided for the sales order (step 308). That is, when the demand of the sales order is larger than the available amount of the product from the semiconductor foundry, only the available amount of the product from the semiconductor foundry can be provided. On the other hand, when the demand of the sales order is smaller than the available amount of the product from the semiconductor foundry, the demand of the sales order can be satisfied.

If the products of the sales order 300 need to be subject to the backend process, then the system of the present invention goes to search for an available amount of product in a warehouse of the semiconductor foundry. The available products in the warehouse are subtracted from the demand of the sales order (step 310). Then, the system goes to search for the CTP capacity for the backend process and the available products to estimate how many products should be further provided (step 312). The available machine capacity (min./machine) at the backend process satisfying the demand of the sales order is calculated. For example, when the product is obtained in the backend process at 1 min./unit, it requires 1000 min/machine of CTP capacity for 1000 units of wafers which need to be subject to the backend process.

The system takes the smaller value as a balanced amount for the sales order, after comparison between the CTP capacity for the backend process and the available products in the semiconductor foundry (step 314). Then, the available products in the warehouse plus the balanced products equals to the products that can be supplied for the sales order (step 316). That is, when the CTP capacity for the backend process is not sufficient for the wafers provided by the foundry, only the CTP capacity from the backend process can be provided for sales order. On the other hand, if the CTP capacity for the backend process is enough, the balanced products can be provided and the demand of the sales order can be thus satisfied.

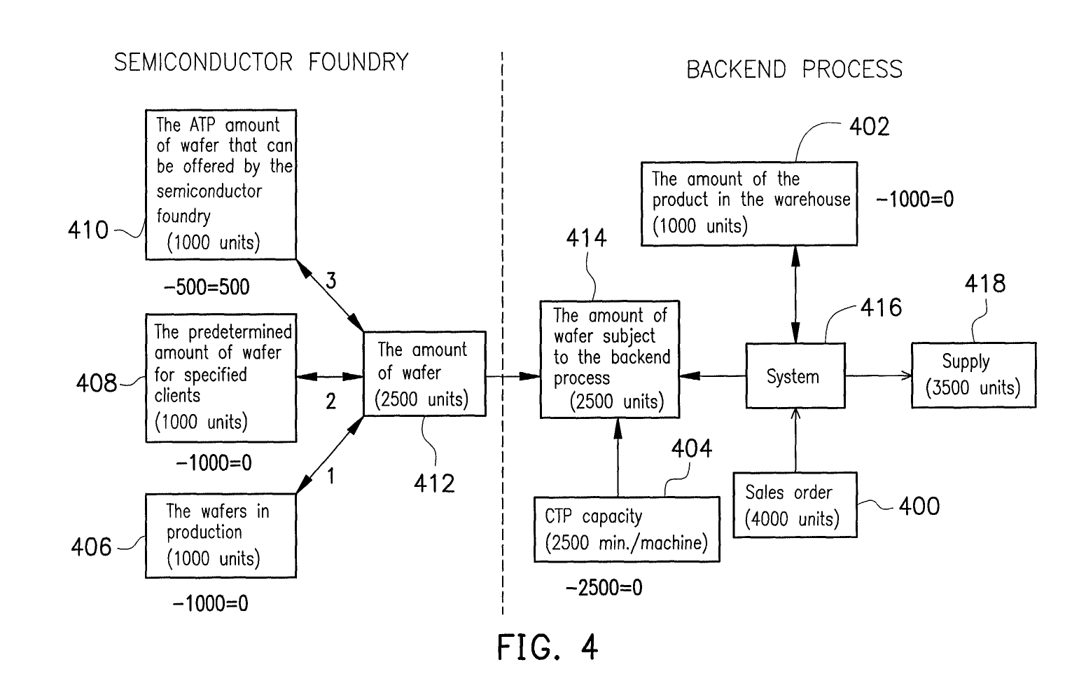

Referring to FIG. 4, when a system 416 is informed that the demand of the sales order 400 is 4000 units, the system 416 goes to search for the available products in the warehouse (step 402). Then, the system 416 subtracts the available products in the warehouse from the demand of the sales order, and finds out 3000 units of the product still needed.

Therefore, the system 416 begins searching for the available machine capacity 404 for the backend process and finds that there is 2500 min./machine of available machine capacity still available. If it is presumed that the cycle time of the backend process is set at 1 unit/min, then it takes 2500 minutes to produce 2500 units of the product in the backend process. Meanwhile, the system 416 searches for whether the semiconductor foundry can provide 2500 units of wafers for the backend process to satisfy the demand of the sales order.

In general, the wafers offered by the semiconductor foundry include the wafers in production 406, predetermined amount of wafer available for the specific clients 408 and ATP amount of wafer that can be supplied by the semiconductor foundry 410. The ATP amount of wafer is provided for the specific clients in case of overloaded demand or to other non-specific clients.

If the wafers in production (amount 406), the predetermined amount of wafer for the specific clients (amount 408) and the ATP amount of wafer (amount 410) are each 1000 units, then the system 416 goes to search for the wafers 406 in production, the predetermined amount 408 of wafer for the specific clients and the ATP amount 410 of wafer. In one preferred embodiment of the present invention, there is only 2500 min./machine of CTP capacity available for the backend process. The system 406 gets 1000 units from the wafers 406 in production in the semiconductor foundry, another 1000 units from the predetermined amount 408 of wafer available for the specific clients, and 500 units from the ATP amount 410 of wafer. Therefore, total amount of 2500 units of wafer 412 is obtained and subject to the backend process (amount 414). It needs 2500 min./machine of CTP capacity 404 to achieve the above object throughput. Therefore, the 2500 units of product produced in the backend process and the 1000 units of available products in the warehouse 402 can be provided for supply 418 of 3500 units of the product to the client.

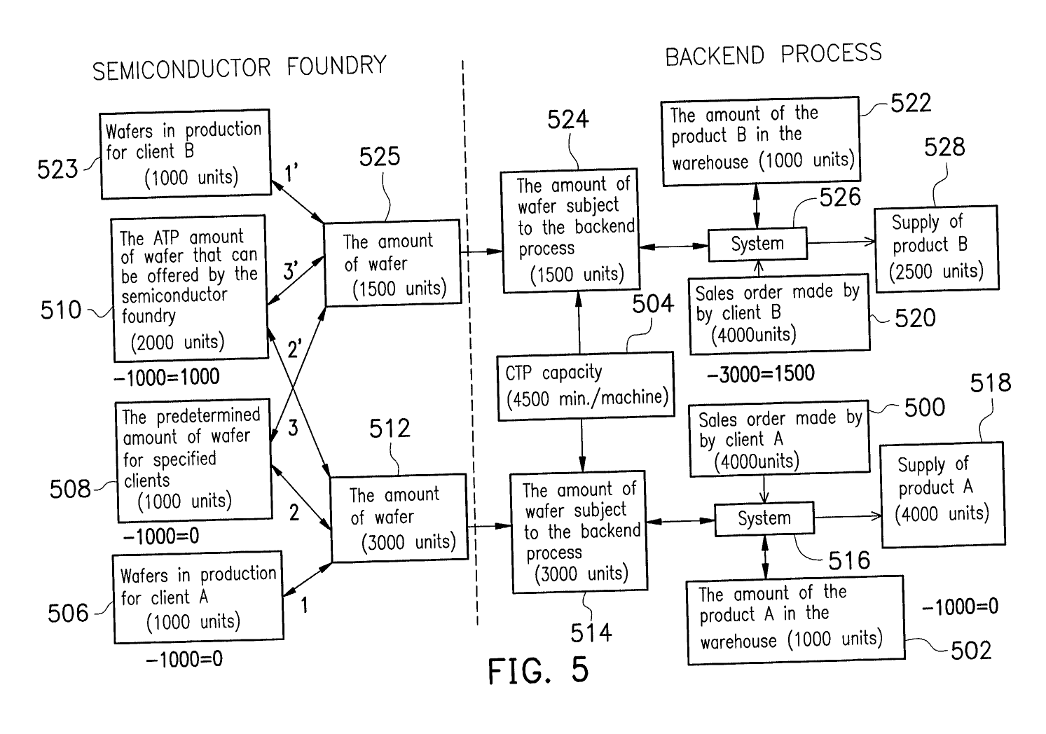

FIG. 5 is a flow chart of a production schedule for two products which are subject the same processes according to one preferred embodiment of the present invention.

With reference to FIG. 5, a sales order 500 that needs 4000 unit of product A is received from client A. The system 516 goes to search for the available products A in the warehouse 502 and finds 1000 units of product A available. Then, the system 516 subtracts the available products A from the demand of the sales order. There are 3000 units of product A still required to satisfy the demand of the sales order. Therefore, the system 516 starts to search for the CTP 504 and finds capacity of 4500 min./machine available. If the cycle time of product A in the backend process is 1 minute per unit of product, then the capacity of 4500 min./machine can provide 4500 units of product A in the backend process. As such, the system 516 subtracts the capacity of 3000 min./machine from the CTP capacity 504. At the same time, the system 516 confirms if the semiconductor foundry can provide 3000 units of wafers to accomplish the production of product A.

The system 516 finds that there are 1000 units of wafer in production of semiconductor foundry for the client A (amount 506), 1000 units of wafer for specific clients (amount 508) and 2000 units of wafer for future production (amount 510). The wafers for future production (amount 510) are provided to the specific clients when they need more than the semiconductor foundry's forecast and/or to other non-specific clients.

Therefore, the system 516 takes 1000 units from the amount 506, 1000 units from the amount 508 and 1000 units from the amount 510 and obtains total amount 512 of 3000 units. 3000 units of wafer are considered as the wafers subject to the backend process (amount 514). Therefore, 3000 min./machine of the CTP capacity 504 are required to accomplish the production of product A in the backend process. The 3000 units of the product A thus obtained and the 1000 units of the available products A in the warehouse 502 can be the supply 518 for the client A, 4000 units of product A.

In the case that a client B makes a sales order 520 that needs 4000 units of product B after the client A, the product B being subject to the same process as the product A, the system 526 goes to search for how many products B are available in the warehouse 522 and finds 1000 units of product B available. Thereafter, the system 526 subtracts the available amount of product B in the warehouse from the demand of the sales order. There are still 3000 units of product B required.

Therefore, the system 526 starts to search for the CTP capacity 504 for the backend process and finds the capacity of 1500 min./machine available. If the cycle time of product B in the backend process is 1 minute per unit of product, then the available capacity of 1500 min./machine can provide 1500 units of product B in the backend process. At the same time, the system 526 confirms if the semiconductor foundry can provide 1500 units of wafers to accomplish the production of product B.

The system 516 finds that there are 1000 units of wafer in production of semiconductor foundry for the client B (amount 523). No wafer is available after the amount 508 of wafer is provided to the specific clients. 1000 units of wafer remains after the amount 510 of wafer is provided to the client A. Therefore, the semiconductor foundry can offer total amount of 2000 units of product B. However, there is a CTP capacity of only 1500 min./machine available in the backend process for product B. Therefore, the system 526 takes 1000 units from the wafer amount 524 and 500 units from the wafer amount 510 and obtains total amount 525 of 1500 units. 1500 units of wafer are considered as the amount 524 of wafer subject to the backend process. It requires CTP 504 of 1500 min./machine in the backend process to accomplish the production of product B. The 1500 units of the product B thus obtained and the 1000 units of the product B available from the warehouse 522 can be the supply 518 of 4000 units of product B for the client B.

While the preferred embodiment of the present invention has been illustrated and described through the exemplification of supply/demand for one or two products, it will be appreciated that the present invention can be applied to planning the production schedule for more than two products.

Form a view of foregoing, the present invention can provide the following advantages:

1. With the method of planning the production schedule according to the present invention, the planner can be informed in several seconds about the throughput the semiconductor foundry, such that it can be confirmed if the sales order can be satisfied in short time.

2. The method of planning a production schedule according to the present invention helps the production schedule planner use capacity information for various processes to confirm the sales order more exactly.

3. In the method of the present invention, different production lines in the semiconductor foundry can respond dynamically and instantaneously by quantifying conditions such as amount or period.

It will be apparent to those skilled in the art that various modifications and variations can be made to the structure of the present invention without departing from the scope or spirit of the invention. In view of the forgoing, it is intended that the present invention cover modification and variation of this invention provided they fall within the scope of the following claims and their equivalents.

What is claimed is:

1. A method of planning a production schedule, which is useful for a semiconductor foundry, comprising:
Entering a demand of a sales order made by a client, wherein the product is not subject to a backend process;
Searching for the available products in the semiconductor foundry; and
Comparing the demand of the sales order with the available products and taking the smaller one as the supply for the sales order.

2. A method of planning a production schedule, comprising:
Entering a demand of a sales order made by a client, wherein the product is subject to a backend process;
Subtracting available product in the warehouse from the demand of the sales order, and obtaining a balanced amount of the product which is still required;
Searching for the supplied amount of the wafers that can be provided from the semiconductor foundry and searching for the CTP capacity available for the backend process;
Comparing the supplied amount of the wafer that can be provided from the semiconductor foundry with the CTP capacity available for the backend process, and taking the smaller one as the supply for the balanced amount of the product; and
Adding the available products in the warehouse to the balanced amount of the product, and obtaining a total amount of the product as the supply for the sales order.

3. The method of planning a production schedule of claim 2, wherein the supplied amount of the wafer that can be provided from the semiconductor foundry includes the wafers in production, predetermined amount of wafer for specific clients and ATP (Available To Promise) amount of wafer supplied by the semiconductor foundry.

4. The method of planning a production schedule of claim 3, wherein searching for the supplied amount of the product that can be provided from the semiconductor foundry is achieved by searching the amount of wafer in production, the predetermined amount of wafer for specific clients and the ATP amount of wafer.

5. The method of planning a production schedule of claim 3, wherein the ATP amount of wafer supplied by the semiconductor foundry is offered to the specific clients in case of overloaded demand and/or to non-specific clients.

6. A method of planning a production schedule in a semiconductor foundry, comprising:
entering a first sales order made by a client A, wherein a product in the first sales order needs to be subject to the backend process;
subtracting available product in a first warehouse from the demand of the first sales order, and obtaining a first balanced amount of the product which is still required;
searching for the CTP capacity for the backend process and in turn searching for a first supplied amount of the wafer that can be provided from the semiconductor foundry;
comparing the supplied amount of the wafer that can be provided from the semiconductor foundry with the CTP capacity for the backend process, and taking the smaller one as the first balanced amount of the product; and
adding the available products in the first warehouse to the balanced amount of the product, and obtaining a total amount of the product as the supply for the first sales order;
entering a second sales order made by a client B, wherein the product in the second sales order needs to be subject to the same process as the first sales order;
subtracting available products in a second warehouse from the demand of the second sales order, and obtaining a second balanced amount of the product which is still required;
searching for the remaining CTP capacity available for the backend process and searching for a second supplied amount of the wafer that can be provided from the semiconductor foundry, wherein the remaining CTP capacity available for the backend process is obtained by subtracting the first balanced amount of the product from the CTP capacity available for the backend process;
comparing the second supplied amount of the wafer with the remaining CTP capacity, and taking the smaller one as the second balanced amount of the product; and
adding the available products in the second warehouse to the second balanced amount of the product, and obtaining a total amount of the product as the supply for the second sales order.

7. The method of planning a production schedule of claim 6, wherein the first supplied amount of the product that can be provided from the semiconductor foundry includes the wafers in production for the client A, a predetermined amount of wafer for specific clients and ATP amount of wafer.

8. The method of planning a production schedule of claim 7, wherein the ATP amount of wafer supplied by the semiconductor foundry is offered to the specific clients for overloaded demand and/or to non-specific clients.

9. The method of planning a production schedule of claim 7, wherein searching for the first supplied amount of the product that can be provided from the semiconductor foundry is achieved by searching the amount of wafer in production for the client A, the predetermined amount of wafer for specific clients and the ATP amount of wafer.

10. The method of planning a production schedule of claim 7, wherein the seconds supplied amount of the wafer that can be provided from the semiconductor foundry includes the wafers in production for the client B, a predetermined amount of wafer for specific clients and an ATP amount of wafer.

11. The method of planning a production schedule of claim 10, wherein searching for the second supplied amount of the product that can be provided from the semiconductor foundry is achieved by searching the amount of wafer in production for the client B, the predetermined amount of wafer for specific clients and the ATP amount of wafer.
